(19) United States
(12) Patent Application Publication
(10) Pub. No.: US 2026/0249301 A1
(43) Pub. Date: Aug. 27, 2026

(54) JAW ASSEMBLY OF A JAW CRUSHER

(71) Applicant: SANDVIK LTD, Dungannon (GB)

(72) Inventors: Stuart SMYTH, Dungannon (GB); Stuart GRAYDON, Dungannon (GB); Adam BAXTER, Dungannon (GB)

(21) Appl. No.: 18/874,734

(22) PCT Filed: Jun. 19, 2023
(86) PCT No.: PCT/EP2023/066391

§ 371 Date: Dec. 13, 2024

(30) Foreign Application Priority Data
Jun. 21, 2022 (EP) 22180041.0

(51) Int. Cl. B02C 1/10; B02C 1/04

(52) U.S. Cl. CPC B02C 1/10; B02C 1/04; B02C 2210/02

(57) ABSTRACT

A jaw assembly of a jaw crusher includes a jaw liner. The frame has a support face that in use abuts the rear face of the jaw liner and a first retention plate arranged to clamp the top of the jaw liner to the support face. The first retention plate has a base that in use abuts the top of the jaw liner. A retainer assembly limits lateral movement of the jaw liner relative to the frame. The retainer assembly includes a first recess located in an upper part the rear face of the jaw liner, and a second recess disposed in the base of the first retention plate. A removable retainer insert that extends through the top of the jaw liner includes a head part that is accommodated within the second recess and an anchor part that is accommodated within the first recess.

### FIELD OF THE INVENTION

The present invention relates to a jaw assembly of a jaw crusher. The invention also relates to a jaw crusher comprising a jaw assembly.

### BACKGROUND TO THE INVENTION

Jaw crusher units typically comprise a fixed jaw and a movable jaw that together define a crushing zone. A drive mechanism is operative to rock the movable jaw back and forth in order to crush material within this zone. The crushing zone is generally convergent towards its lower discharge end so that crushable material, fed to an upper and wider end of the zone, is capable of falling downward under gravity whilst being subject to repeated cycles of crushing movement in response to the cyclical motion of the movable jaw. The crushed material is then discharged under gravity through the lower discharge end onto a conveyor belt for onward processing or to a suitable stockpile.

Due to the forces exerted on the jaws the jaw liners wear over time and are required to be replaced. Current jaw liners have holes on the working surface for receipt of lifting hooks when the jaw liners are to be replaced. These holes add cost and complexity to the process of casting the jaw liners and also reduce the efficiency of the crushing operation.

Current jaw liners also incorporate retention assemblies that are intended to limit lateral movement of the jaw liner relative to the jawstock (frame). The retention assembly comprises internally cast spigots that interface with the rear face of the jaw liners. The lateral retention spigots can and do shear off if a large crushing force is experienced and to repair the casting is expensive and time intensive.

It is an objective of the invention to overcome at least one of the above-referenced problems.

### SUMMARY OF THE INVENTION

The objective is met by the provision of a jaw assembly for a jaw crusher that comprises a lateral retainer insert that couples the top of the jaw liner with an underside of a retainer plate such as a retainer wedge plate. The insert has a head portion that is accommodated in a recess in the base of the retention plate and an anchor portion that is accommodated in a recess in a rear of the jaw liner. The recesses are not exposed at the front of the jaw liner and thus provide protection for the insert. The retainer insert is also frangible so that when the jaw assembly encounters heavy loads, it breaks allowing the jaw liner to move and avoid structural damage to the fixed Jaw. Additionally, as the head portion of the retainer insert is exposed proud of the top of the jaw liner (See FIGS. 5 and 6), it can function as a lifting attachment when the jaw liner needs to be replaced or rotated.

In a first aspect, the invention provides a jaw assembly of a jaw crusher, comprising:
a jaw liner having a front working face, a rear face, a top, and a bottom;
a frame forming part of a jaw, the frame having a support face that in use abuts the rear face of the jaw liner;
a first retention plate to clamp the top of the jaw liner to the support face, the first retention plate having a base that in use abuts the top of the jaw liner; and
a retainer assembly to limit lateral movement of the jaw liner relative to the frame

In any embodiment, the retainer assembly comprises:
a first recess in an upper part the rear face of the jaw liner;
a second recess disposed in the base of the first retention plate; and
a removable retainer insert that extends through the top of the jaw liner and comprises a head part that is accommodated within the second recess and an anchor part that is accommodated within the first recess.

In any embodiment, the head part of the retainer insert comprises a lifting eye.

In any embodiment, the retainer insert is frangible.

In any embodiment, the retainer insert comprises a bolt having a first end comprising the head part and a second part that is threaded, and a corresponding threaded nut.

In any embodiment, the jaw assembly comprises a first retainer assembly disposed towards each side of the jaw liner and one (or more) second retainer assembly disposed towards a centre of the jaw liner.

In any embodiment, a tolerance defined between the second recess and head part of the second retainer is larger than a tolerance defined between second recess and head part of the first retainer.

In any embodiment, the jaw assembly comprises two first retainer assemblies and two second retainer assemblies disposed at a top of the jaw assembly.

In any embodiment, the first recess extends across part or all of the jaw liner to define an inwardly projecting flange in the top of the jaw liner.

In any embodiment, the or each second recess is formed in the base and a rear of the retention wedge plate.

In any embodiment, the jaw assembly further comprises a second retention plate to clamp the bottom of the jaw liner to the support face, the second retention plate having a top that in use abuts the bottom of the jaw liner.

In any embodiment, the jaw assembly comprises:
a second retention plate to clamp the bottom of the jaw liner to the support face, the second retention plate having a top that in use abuts the bottom of the jaw liner;
a first recess in a lower part the rear face of the jaw liner; and
a removable retainer insert that extends through the bottom of the jaw liner and comprises an anchor part that is accommodated within the first recess and a head part that couples with a side of the second retention plate.

In any embodiment, the first retention plate and/or second retention plate is a retention wedge plate.

In any embodiment, the second recess is disposed in (e.g. comprises an opening formed in) the base and rear of the first retention plate.

In another aspect, the invention provides a jaw of a jaw crusher, comprising a jaw assembly of the invention.

In another aspect, the invention provides a jaw crusher comprising a stationary jaw and a mobile jaw, wherein one of the stationary jaw and a mobile jaw comprise a jaw assembly according to the invention.

Other aspects and preferred embodiments of the invention are defined and described in the other claims set out below.

### BRIEF DESCRIPTION OF THE FIGURES

FIG. 1 is a perspective view of a jaw crusher of the invention.

FIG. 2 is another perspective view of the jaw crusher of FIG. 1.

FIG. 3 is a perspective view of a jaw liner forming part of a jaw assembly of the invention.

FIG. 4 is a perspective cross-sectional view taken along the lines IV-IV of FIG. 3.

FIG. 5 is a perspective view of a jaw liner forming part of a jaw assembly of the invention with the retainer inserts in-situ.

FIG. 6 is a perspective cross-sectional view taken along the lines VI-VI of FIG. 5.

FIG. 7 is a side elevational, cross-sectional view of a jaw assembly according to the invention.

FIG. 8 is a perspective view of a retainer insert forming part of the jaw assembly of the invention.

FIG. 9 is a perspective view of a first retention wedge plate showing the two second recesses.

FIG. 10 is a rear plan view of the first retention wedge plate of FIG. 9.

FIG. 11 is a side elevational sectional view of the jaw assembly of the invention.

FIG. 12 is a front perspective view of the jaw assembly of the invention.

FIG. 13 is a front perspective view of the jaw assembly of the invention with a front part of the two retention wedge plates cut-away to show the second recesses accommodating the hear parts of the retainer inserts.

FIG. 14 is a front elevational view of part of the base of the jaw liner showing how it is retained by the lower retainer plate.

FIG. 15 is a perspective view of part of the base of the jaw liner showing how it is retained by the lower retainer plate.

FIG. 16 is a front perspective view of the jaw assembly of the invention with the retainer wedge plates removed and lifting attachments coupled to the head part of the retainer inserts.

FIG. 17 shows lifting chains attached to the lifting attachments.

### DETAILED DESCRIPTION OF THE INVENTION

All publications, patents, patent applications and other references mentioned herein are hereby incorporated by reference in their entireties for all purposes as if each individual publication, patent or patent application were specifically and individually indicated to be incorporated by reference and the content thereof recited in full.

Where used herein and unless specifically indicated otherwise, the following terms are intended to have the following meanings in addition to any broader (or narrower) meanings the terms might enjoy in the art:

Unless otherwise required by context, the use herein of the singular is to be read to include the plural and vice versa. The term “a” or “an” used in relation to an entity is to be read to refer to one or more of that entity. As such, the terms “a” (or “an”), “one or more,” and “at least one” are used interchangeably herein.

As used herein, the term “comprise,” or variations thereof such as “comprises” or “comprising,” are to be read to indicate the inclusion of any recited integer (e.g. a feature, element, characteristic, property, method/process step or limitation) or group of integers (e.g. features, element, characteristics, properties, method/process steps or limitations) but not the exclusion of any other integer or group of integers. Thus, as used herein the term “comprising” is inclusive or open-ended and does not exclude additional, unrecited integers or method/process steps.

### Exemplification

The invention will now be described with reference to specific Examples. These are merely exemplary and for illustrative purposes only: they are not intended to be limiting in any way to the scope of the monopoly claimed or to the invention described. These examples constitute the best mode currently contemplated for practicing the invention.

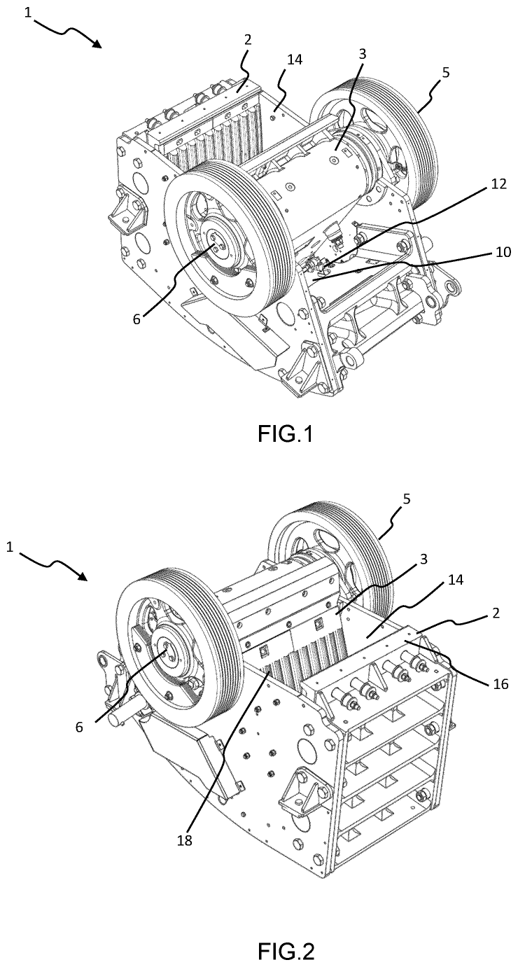

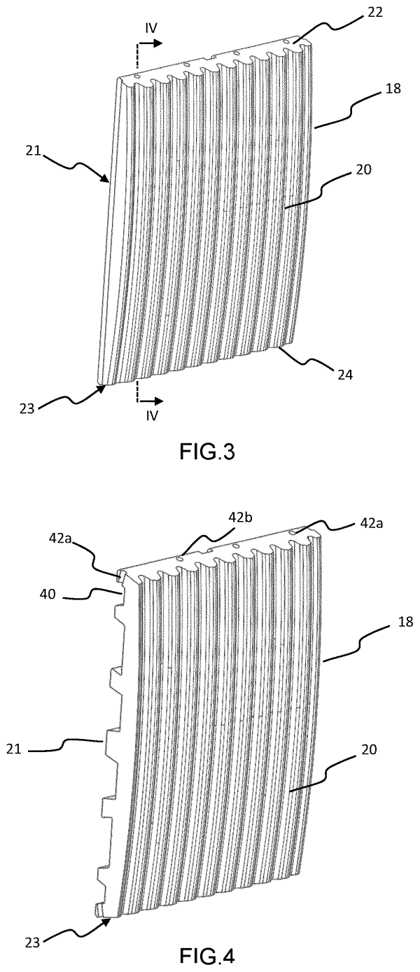

Referring in particular to FIGS. 1 and 2 of the drawings, there is shown a jaw crusher, generally indicated as 1. The jaw crusher 1 is of a general type commonly used in material processing operations to crush rocks or other crushable material. Typically, the crusher 1 is installed on a material processing apparatus (not shown), which includes other components that co-operate directly or indirectly with the crusher 1, for example conveyor(s), feeder(s), hopper(s) and/or screen(s), all of which may be mounted on a chassis (with wheel(s) and/or track(s)) or other base. The jaw crusher 1 comprises first and second opposed crushing jaws 2, 3, at least one of which is movable with respect to the other to enable the jaws 2, 3 to crush material between the jaws 2, 3. In typical embodiments, the first jaw 2 is fixed and the second jaw 3 is movable towards and away from the first jaw 2 in an oscillatory manner.

A drive system is provided for moving the, or each, movable jaw. Typically the drive system comprises a rotatable wheel 5 (typically a fly wheel) coupled to an eccentric shaft 6, the shaft 6 being coupled to one end of the movable jaw 3. The movable jaw 3 is also coupled to a toggle mechanism 8, which typically includes a toggle plate 10 and a tensioning rod and spring or ram assembly 12. A motor (not shown) is coupled to the wheel 5, for example by a drive belt (not shown), for the rotation thereof. In use, the motor rotates the wheel 5 causing the upper end of the jaw 3 to oscillate, while the toggle mechanism 8 causes or facilitates oscillatory movement of the lower end of the jaw 3.

Typically, side walls 14 are provided beside the jaws 2, 3 to form, together with the jaws 2, 3, a crushing chamber. All of the crusher components may be provided on any suitable base (not shown).

Each jaw 2, 3 comprises a frame 16 (which may be referred to as a jawstock) and a jaw liner 18. Each jaw liner 18 has a working (crushing) surface 20, a rear surface 21, a top part 22 and a bottom part 23. The respective crushing surfaces oppose one another so that material can be crushed therebetween. The crushing surfaces 20 may be fluted, comprising a plurality of parallel ridges 24. Each ridge 24 typically extends in a top-to-bottom direction of the jaw liner 18. The jaw liners 18 are typically plate-like in form (and may be referred to as jaw plates). The crushing surfaces 20 are typically rectangular. Each jaw liner 18 is removable from the respective jawstock 16 to allow it to be replaced, for example in the event that it becomes overly worn through use.

In the illustrated embodiment, each of the jaw liners 18 is removable. In alternative embodiments, only one of the jaw liners may be removable. Alternatively still, one of the crushing surfaces may be integrally formed with the respective jawstock rather than being formed on a jaw liner.

The jaw liners 18 are secured in place on the respective jawstock 16 by a first (upper) retention wedge plate 25 and a second (lower) retention wedge plate 26.

The retainer wedge plates 25, 26 are shaped and dimensioned to be wedged between a jaw liner 18 and frame 16 in order to hold the liner in place. To this end, the frame 16 may be shaped to define a recess 30 adjacent the jaw liner 18 (when fitted) into which the locking wedge plate 25, 26 may be wedged. The wedge plates are secured to the frame by bolts 35 that extend through holes 36 in the plates and holes 37 in the frame and are locked with locking nuts 38. In the embodiment shown, the first retention wedge plate 25 is provided by two retainer wedge plates 25a and 25b vertically symmetrical about the centre.

The rear surface 21 of the jaw liner 18 includes a first recess 40 that extends across a top of the jaw liner and defines an inwardly extending flange 41 that forms part of the top part 22 of the jaw liner. The flange 41 includes four through holes 42, two lateral through holes 42a and two central through holes 42b. Each through hole 42 extends from the first recess 40 through to the top of the jaw liner.

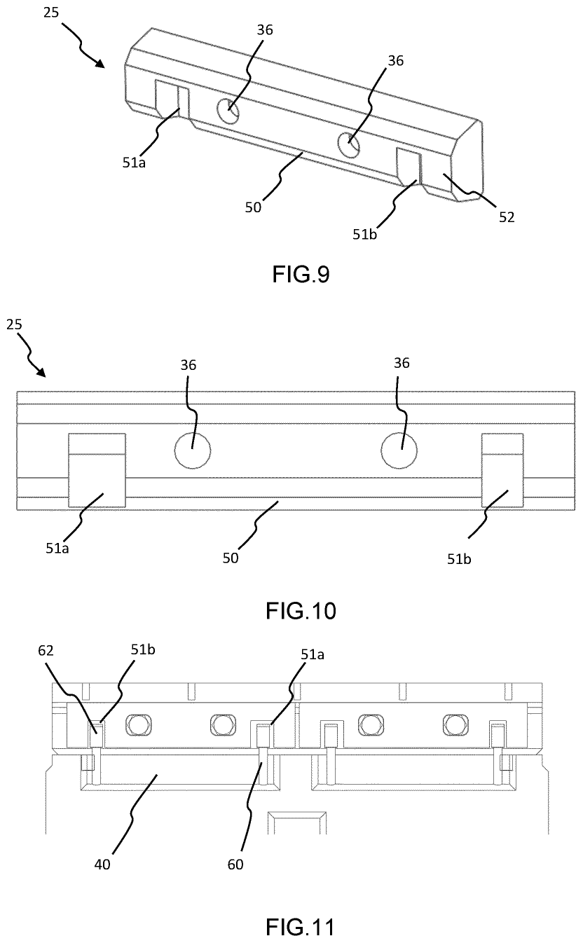

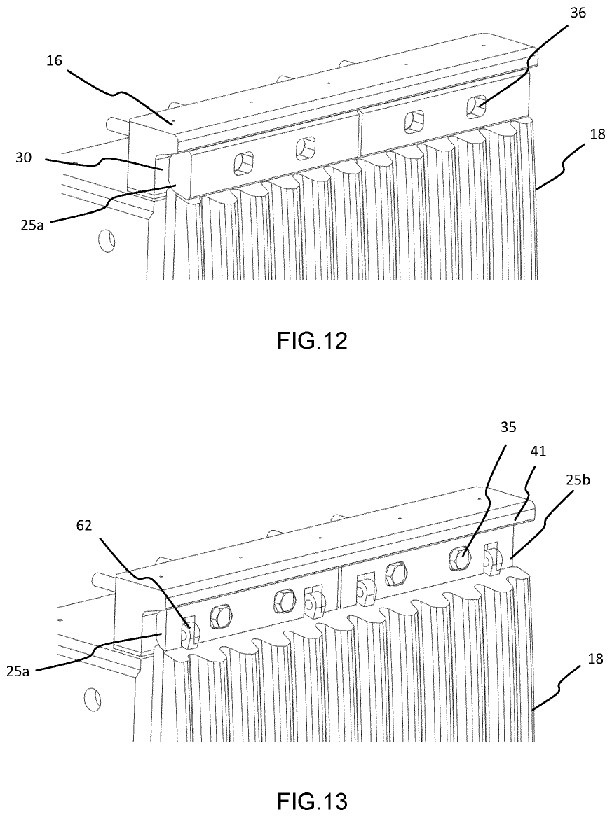

Referring to FIGS. 9 and 10, one of the retainer wedge plates 25a, 25b is illustrated. The plate has a wedge-shaped base 50 including two second recesses 51a and 51b that are formed in a rear 52 and base 50 of the plate. As illustrated in FIG. 10, the recess 51a that in use is located above a centre of the jaw liner 18 is larger than the recess 51b that in use is located above a side of the jaw liner.

The jaw assembly of the invention includes a retainer assembly to secure the jaw liner 18 relative to the frame 16 and limit lateral movement therebetween. This is achieved by providing a retainer insert 60 that couples the jaw liner to the retainer wedge plate. The insert is illustrated in FIG. 8 and comprises a bolt 61 with a head part 62 at one end and a threaded second end 63 and corresponding threaded nut 64 which forms the anchor part of the insert. The head part 62 includes a lifting eye 65. The bolt has a length enabling it to project through the flange 41 forming part of the top of the jaw liner 18. The head part 62 is dimensioned to be accommodated within the recesses 51a and 51b, with the tolerance between the head part 62 and recess 51a being greater than the tolerance between the head part 62 and recess 51b.

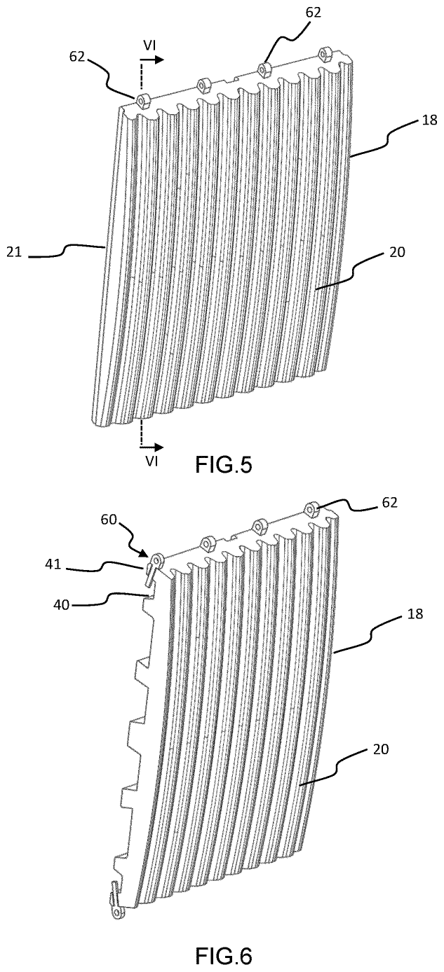

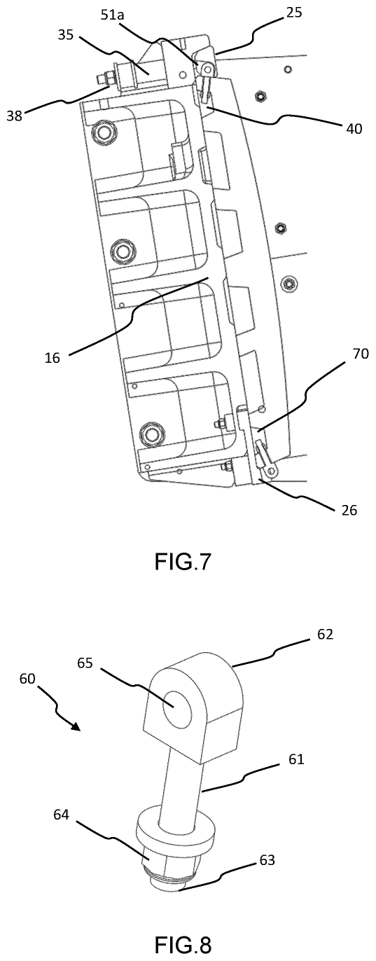

FIGS. 5 and 6 show the jaw liner with the retainer inserts 60 in place. FIG. 7 illustrates the retainer insert 60 projecting through the hole 42 in the flange 41 with the head part 62 located within the second recess 51 and the anchor part located within the first recess 40.

FIG. 13 is a front perspective view of a jaw assembly of the invention in which a front section of the retainer wedge plates 25a, 25b is removed to show the second recesses 51 with the head parts 62 located in the recesses.

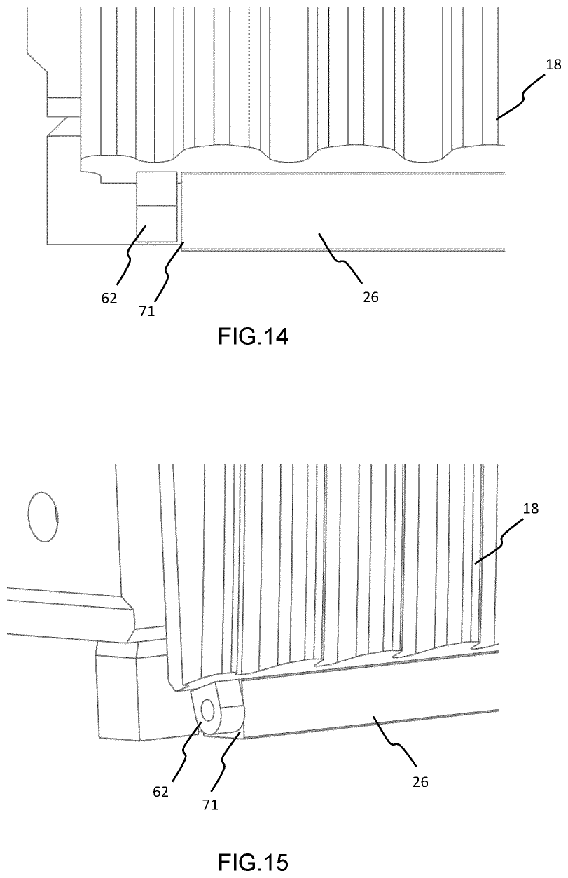

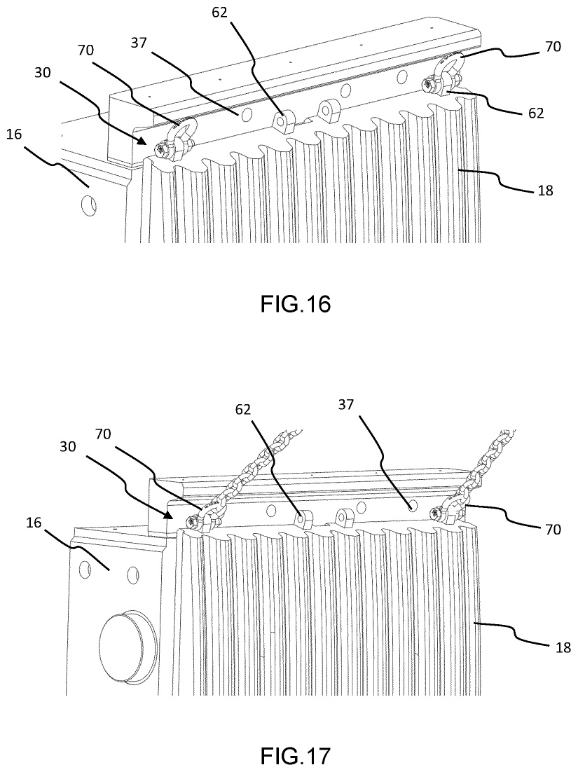

Referring to FIGS. 14 and 15, part of the base of the jaw liner 18 is illustrated in more detail. The jaw liner is retained in position by a second (lower) retention wedge plate 26 which abuts the base of the jaw liner. The rear base of the jaw liner includes a first recess 70, and a retention insert 60 which is similar to that described previously couples the base of the jaw liner to the wedge plate 26 with an anchor part of the insert 60 being accommodated in the recess 70 and the head part 62 engaging a side 71 of the wedge plate 26.

FIGS. 16 and 17 illustrate the use of the jaw assembly during removal of the jaw liner. In FIG. 16, the two retainer wedge plates 25a, 25b are removed by unscrewing the bolts 35 and detaching the plates 25a, 25b to expose the top of the jaw liner 18 and the head parts 62 of the retainer inserts 60 that extend proud above the top of the plate. A lifting eye 70 is then attached to each head part 62, and then lifting chains 72 are attached to the lifting eye as illustrated in FIG. 17 allowing the jaw liner to be lifted by a hoist.

The benefits of this invention are the replaceability in case of large failure loads the retainer insert will fracture saving the expensive cast items. The recess in the wedge plate provides protection to the retainer insert during normal operation where otherwise it could be subjected to material flow and subsequent wear.

Further to this, the removable insert can interface with conventional lifting equipment, this allows the jaw liner to be safely lifted and turned or replaced.

### Equivalents

The foregoing description details presently preferred embodiments of the present invention. Numerous modifications and variations in practice thereof are expected to occur to those skilled in the art upon consideration of these descriptions. Those modifications and variations are intended to be encompassed within the claims appended hereto.

1. A jaw assembly of a jaw crusher the jaw assembly comprising:
a jaw liner having a front working face a rear face a top and a bottom
a frame forming part of a jaw the frame having a support face that in use abuts the rear face of the jaw liner
a first retention plate arranged to clamp the top of the jaw liner to the support face, the first retention plate having a base that in use abuts the top of the jaw liner; and
a retainer assembly arranged to limit lateral movement of the jaw liner relative to the frame wherein the retainer assembly comprises:
a first recess located in an upper part of the rear face of the jaw liner
a second recess disposed in the base of the first retention plate and
a removable retainer insert that extends through the top of the jaw liner and includes a head part that is accommodated within the second recess and an anchor part that is accommodated within the first recess.

2. The jaw assembly according to claim 1, wherein the head part of the retainer insert includes a lifting eye.

3. The jaw assembly according to claim 1, wherein the retainer insert is frangible.

4. The jaw assembly according to claim 3, wherein the retainer insert includes a bolt having a first end comprising including the head part and a second part that is threaded, and a corresponding threaded nut.

5. The jaw assembly according to claim 1, further comprising at least one first retainer assembly disposed towards each side of the jaw liner and at least one second retainer disposed towards a center of the jaw liner, in which a tolerance defined between the second recess and head part of the second retainer is larger than a tolerance defined between second recess and head part of the first retainer.

6. The jaw assembly according to claim 5, wherein the at least one first retainer assembly comprises two first retainer assemblies and the at least one second retainer assembly comprises two second retainer assemblies disposed at a top of the jaw assembly.

7. The jaw assembly according to claim 1, wherein the first recess extends across the rear face of the jaw liner to define an inwardly projecting flange in the top of the jaw liner.

8. The jaw assembly according to claim 1, wherein each second recess is formed from a recess in the base and a rear of the retention wedge plate

9. The jaw assembly according to claim 1, further comprising:
a second retention plate arranged to clamp the bottom of the jaw liner to the support face, the second retention plate having a top that in use abuts the bottom of the jaw liner;
a first recess in a lower part the rear face of the jaw liner; and
a removable retainer insert that extends through the bottom of the jaw liner and includes an anchor part that is accommodated within the first recess and a head part that couples with a side of the second retention plate.

10. The jaw assembly according to claim 1, wherein the first retention plate is a retention wedge plate.

11. The jaw assembly according to claim 1, wherein the second recess is disposed in the base and rear of the first retention plate.

12. A jaw of a jaw crusher the jaw including a jaw assembly according to claim 1.

13. A jaw crusher comprising a stationary jaw and a moving jaw wherein one of the stationary jaw and the moving jaw includes a jaw assembly according to claim 1.
